(19) United States
(12) Patent Application Publication
(10) Pub. No.: US 2009/0234529 A1
(43) Pub. Date: Sep. 17, 2009

(54) Method for Processing Data Based on an Evaluation of Real-Time Measurements of Movements of a User in a Vehicle and Based on Statistical Data on User Interactions With Input Devices in the Vehicle

(75) Inventors: Luis Sampedro Diaz, Mountain View, CA (US); Ganymed Stanek, Arth (CH)

Correspondence Address: MANFRED BECK PA, P.O. BOX 431255, SOUTH MIAMI, FL, 33243-1255, US

(73) Assignee: VOLKSWAGEN OF AMERICA, INC., Auburn Hills, MI (US)

(21) Appl. No.: 12/049,291

(22) Filed: Mar. 15, 2008

(51) Int. Cl. G06F 17/00; G06F 15/18

(52) U.S. Cl. 701/29; 706/14

(57) ABSTRACT

A method for processing data includes providing statistical data on user interactions with input devices, which are for example provided in a vehicle, and performing real-time measurements of user movements. A user intent is predicted by evaluating the real-time measurements of the user movements and the statistical data on the user interactions with the input devices. Data required for an imminent output are pre-processed, for example pre-cached, in dependence of the user intent predicted by evaluating the statistical data and the real-time measurements. The method for processing data is advantageous when data must be provided within a short period of time after a user interacts with an input device. For example, map data of an in-vehicle navigation system must be presented on a display screen immediately after a driver requests the map data by actuating an input device.

### BACKGROUND OF THE INVENTION

### Field of the Invention

The invention relates in general to a method for processing data wherein data that are required for an imminent output must be provided within a short period of time after a user interacts with an input device. For example, when a driver presses a button of an in-vehicle navigation system, map data must be presented on a display screen essentially without delay.

In order to make electronic products more attractive to customers, graphical user interfaces have grown in complexity. Graphical interfaces require that video animations, three-dimensional animations, sound effects, etc. are presented to the user only microseconds after pressing a corresponding button of the system.

Conventional methods for solving the problems associated with the increasing complexity of graphical user interfaces generally focus on increasing the processing power and/or the memory capacity of the system. Thus, new graphical user interfaces typically require more processing power and, ultimately, a completely new and more expensive hardware to run it.

Furthermore, a limiting factor for the efficiency of a graphical interface is the fact that the required graphics to be displayed on the display screen are compressed and the corresponding graphics files must be uncompressed prior to displaying the graphics. Another limiting factor for the efficiency of a graphical interface is that the pertinent data may be located in a slow-access storage medium such as a DVD (Digital Versatile Disc) or a hard-drive.

Conventional methods for solving problems associated with a slow access of data stored on a storage medium include the use of a cache memory. General methods for optimizing the access of data stored on a storage medium are for example disclosed in U.S. Pat. No. 7,010,532 B1, U.S. Patent Application Publication No. 2005/0108754 A1 and European Patent Application No. EP 1 400 970 A1.

### SUMMARY OF THE INVENTION

It is accordingly an object of the invention to provide a method for processing data which overcomes the above-mentioned disadvantages of the heretofore-known methods of this general type and which allows operating complex graphical user interfaces in a cost-efficient manner. It is in particular an object of the invention to provide a method for processing data which reduces the need for designing new hardware platforms with more processing power and fast-access memory in order to be able to operate complex graphical user interfaces. Specifically, it would be desirable to provide a method for processing data that optimizes the available processing power and fast-access memory capacity thus allowing the deployment of more complex graphical user interfaces and/or the reduction of the overall cost of the system.

With the foregoing and other objects in view there is provided, in accordance with the invention, a method for processing data, which includes the steps of:

providing statistical data on user interactions with input devices;

performing a real-time measurement of a user movement;

predicting a user intent by evaluating the real-time measurement of the user movement and the statistical data on the user interactions with the input devices; and

pre-processing data required for an imminent output in dependence of the user intent predicted by evaluating the statistical data and the real-time measurement.

An advantage of the above-defined method according to the invention is that it reduces the demands for the image processing power that is required for a given task. The method according to the invention therefore reduces costs associated with the data processing hardware. The method according to the invention makes it possible to use low-cost hardware components for complex graphical user interfaces. Another advantage of the method according to the invention over the prior art is that it provides smoother graphics and animated transitions, especially if the graphics files are located in a relatively slow-access storage medium.

Another mode of the method according to the invention includes detecting an amount of times each of the input devices is actuated in order to provide statistical data on user interactions with the input devices. This measure allows for example an evaluation of how often a user performs certain tasks. Data for tasks that a user performs frequently can advantageously be pre-processed and thus the response time of the system is reduced. For example, data for frequent tasks can be uncompressed and/or pre-cached in order to be immediately available when the task is to be performed. Conversely, data for tasks that are rarely or never performed need not be pre-processed and thus the demands on the hardware are reduced.

Another mode of the method according to the invention includes detecting time stamp information when a respective one of the input devices is actuated in order to provide statistical data on user interactions with the input devices. In accordance with the invention, the step of detecting time stamp information may include detecting at least one item of time information such as the time of the day and the day of the week.

According to another mode of the method of the invention, the step of providing statistical data on user interactions with the input devices includes calculating a probability of choosing a respective one of the input devices in dependence of a given history of inputs previously chosen.

According to another mode of the method of the invention, the step of performing a real-time measurement of a user movement includes measuring a user movement such as a hand movement, a head movement, an eye movement and/or a variation in a weight distribution.

Another mode of the method according to the invention includes measuring a first time period elapsing between a detection of a user movement, such as hand movements, head movements, eye tracking, variations in a weight distribution, and an actuation of an input device; and assessing a second time period available for pre-processing data required for an imminent output in dependence of the first time period elapsed between the detection of the user movement and the actuation of the input device.

Another mode of the method according to the invention includes using touch sensors embedded in respective ones of the input devices in order to provide a real-time measurement of a user movement.

Another mode of the method according to the invention includes using a capacitive touch sensor and/or a resistive touch sensor as a touch sensor, and using a button, a knob, a touchscreen and/or a touchpad as an input device.

According to another mode of the method of the invention, the step of pre-processing data includes at least one of the following data operations: a data file search, a data file uncompressing, a data file assembly, a data file pre-caching and a data file modification. A data file modification may for example be necessary if a part of a map needs to be highlighted, or if some graphics are to be superimposed onto the map. Superimposed graphics may for example be points of interest or routing options.

According to another mode of the method of the invention, the step of pre-processing data includes pre-caching data files for a first imminent output related to a first system state and for a second imminent output related to a second system state, wherein the second system state succeeds the first system state.

According to another mode of the method of the invention, the step of pre-processing data includes pre-caching data files required for an imminent output on a display by moving the data files from a first memory to a second memory, wherein the second memory allows a faster data access than the first memory.

Another mode of the method according to the invention includes identifying a given user; and providing user-specific statistical data on user interactions with the input devices by evaluating the user interactions of the given user in order to ascertain user-specific preferences.

Another mode of the method according to the invention includes providing context-specific statistical data on user interactions with the input devices by evaluating a driving situation.

According to another mode of the method of the invention, the step of evaluating a driving situation includes evaluating information available in a vehicle information network system, such as a CAN (Controller Area Network) bus network system.

According to another mode of the method of the invention, the step of evaluating a driving situation includes evaluating, as a vehicle parameter, a vehicle speed, a steering angle, a gas pedal position, a turning signal activation, a vehicle acceleration and/or a vehicle brake actuation.

Another mode of the method according to the invention includes performing, as a user interaction, a task such as interacting with a stereo system, interacting with a navigation system, interacting with a climate control system and/or interacting with a vehicle information system.

Other features which are considered as characteristic for the invention are set forth in the appended claims.

Although the invention is illustrated and described herein as embodied in a method for processing data based on an evaluation of real-time measurements of movements of a user in a vehicle and based on statistical data on user interactions with input devices in the vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic perspective view of a vehicle interior including a plurality of input regions with input devices according to the invention;

FIG. 2 is a schematic overview for illustrating the basic concept of the method and system according to the invention;

FIG. 3 is a schematic overview for illustrating a process of pre-caching data in view of a number of actuation possibilities of an input device according to the invention;

FIG. 4 is a schematic overview for illustrating an exemplary process of pre-caching successive program states in response to actuating input devices according to the invention;

FIG. 5 is a schematic diagram of an exemplary embodiment of a memory configuration for implementing the method according to the invention;

FIG. 6 is a schematic diagram of a further exemplary embodiment of a memory configuration for implementing the method according to the invention; and

FIG. 7 is a flow chart illustrating basic steps of the method according to the invention.

### DESCRIPTION OF THE PREFERRED EMBODIMENTS

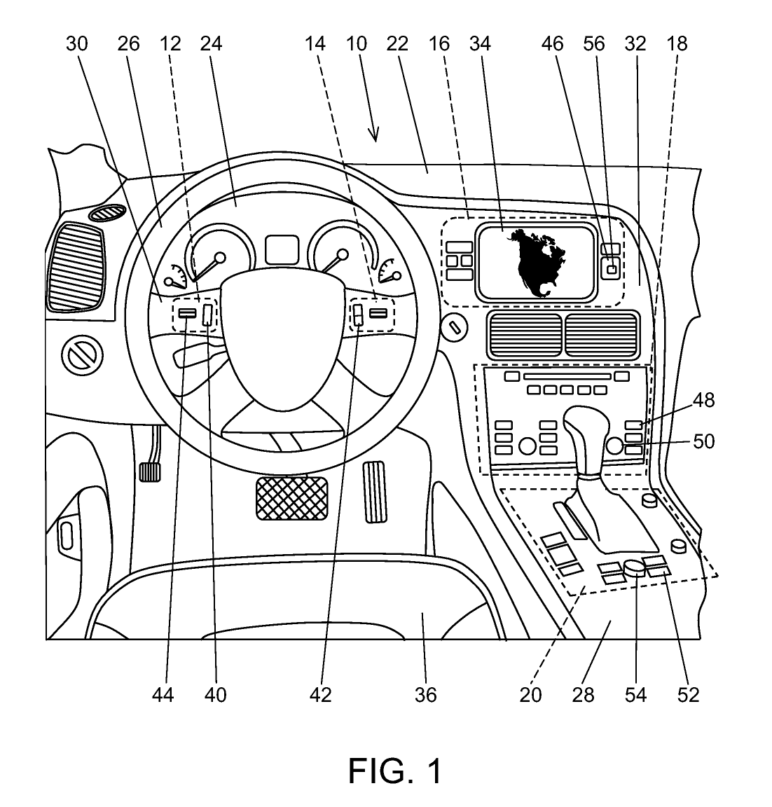

Referring now to the figures of the drawings in detail and first, particularly, to FIG. 1 thereof, there is shown a diagrammatic perspective view of a vehicle interior 10 including a plurality of input regions 12, 14, 16, 18, 20 with input devices according to the invention. The input regions 12, 14, 16, 18, 20 are bounded by dashed lines in FIG. 1.

The vehicle interior 10 includes a dashboard 22 with an instrument panel 24, a steering wheel 26, and a center console 28. The steering wheel 26 has steering wheel spokes 30. The input devices in the input regions 12, 14 on the steering wheel spokes 30 may be embodied as push buttons 40, toggle switches 42, scroll wheels 44 or any other suitable actuation device.

The upper input region 16 on the center stack 32 includes a main display or display screen 34 of an in-vehicle multimedia system. The input devices in the upper input region 16 on the center stack 32 may for example be embodied as push buttons 46, knobs, rotary dials 50 or touch pads disposed adjacent to the display screen 34. The display screen 34 may also be embodied as a touchscreen in order to provide input functions. The input devices can have a touch sensor 56, such as a capacitive touch sensor or a resistive touch sensor, embedded therein.

The lower input region 18 on the center stack 32 includes input devices that are generally used for climate control functions and infotainment functions. The input devices may again be embodied as push buttons 48, scroll wheels, rotary dials 50, touchpads, keyboards or any other suitable actuating device.

A further input region 20 is provided on the center console 28. The input devices in the input region 20 on the center console 28 may for example be embodied as push buttons 52, switches, rotary-push knobs 54 or touch pads.

In accordance with a general exemplary embodiment of the invention, a driver or a passenger in the vehicle may, at any time, interact with the in-vehicle multimedia system, which may for example include a stereo system and a navigation system. The user, in the case the driver or the passenger, may adjust the temperature setting for the cabin, switch the seat heating on or off, or request information on the status of the vehicle such as a fuel consumption, a tire pressure, a temperature inside the cabin or an outside temperature. These requests are relayed to the respective system by a set of input devices, such as buttons, knobs, a touchscreen, and a touchpad. The input devices are placed at various locations within the reach of the driver or other vehicle occupants. The above-described input regions shown in FIG. 1 can be divided into three main input regions.

The first main input region 12, 14 includes the input devices on or very close to the steering wheel 26. In FIG. 1, the first main input region 12, 14 is formed by the input regions 12, 14 on the steering wheel spokes 30. The input devices located in the first main input region 12, 14 can therefore be reached by a slight move of the fingers of the driver as the user. For example, a driver of the vehicle can actuate the input devices located on the spokes 30 of the steering wheel 26 with his or her thumbs.

The second main input region 16 includes the main display or display screen 34 of the in-vehicle multimedia system. As mentioned above, the main display 34 may be a touch screen. In this case, the interaction with this input channel or input device involves a movement of the hand of the user and, potentially, a head movement and/or an eye movement. An interaction with an input device located in the second main input region 16 may also involve that the driver leans towards the center stack 32 of the vehicle in order to reach the input devices located in the second main input region 16. In this case, the weight of the user would shift towards the center stack 32 and thus there would be a change in the weight distribution on the driver's seat 36. Such a change in the weight distribution on the driver's seat 36 can be measured with sensors integrated anywhere in the vehicle seat 36, for example in the seat bottom, in the backrest and/or the seat rails of the vehicle seat 36.

The third main input region 18, 20 is the main input and control area located on the lower portion of the center stack 32 and on the center console 28. The third main input region 18, 20 includes the majority of the input devices such as buttons, rotary knobs, and toggle switches. An interaction with an input device in the third main input region 18, 20 involves a hand movement and, potentially, a head movement, an eye movement, and a change in the weight distribution on the vehicle seat 36. The change in the weight distribution on the vehicle seat 36 is a result of the user's arm extending towards the third main input region 18, 20 and/or a result of the user leaning toward the center stack 32 or the center console 28.

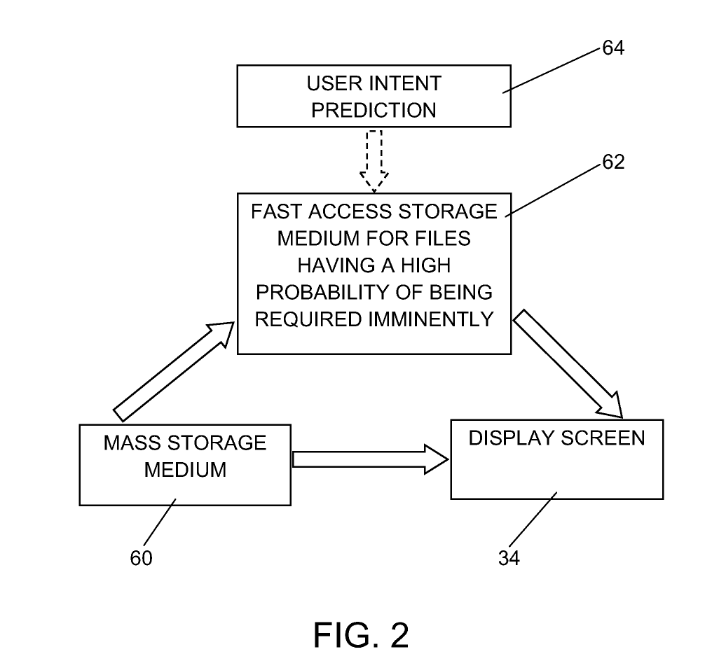

FIG. 2 is a schematic overview for illustrating the basic concept of the method and system according to the invention. A mass storage medium 60 stores data that are used by the system and that will eventually be output using, for example, a display screen 34 of the system. The data to be transferred from the mass storage medium 60 to the display screen 34 may be directly transferred from the mass storage medium 60 to the display screen 34 when the user actuates an input device or the data may be pre-processed and bypassed to a fast access storage medium 62. The fast access storage medium 62 is configured to store a pool of files that have a high probability of being required imminently. The probability of a data file being required for an imminent output is determined by a user intent prediction 64. Since the pool of files which are probably required imminently is stored in the fast access storage medium 62, data are provided to the display screen 34 much faster in response to an actuation of an input device than data that are provided by the mass storage medium 60.

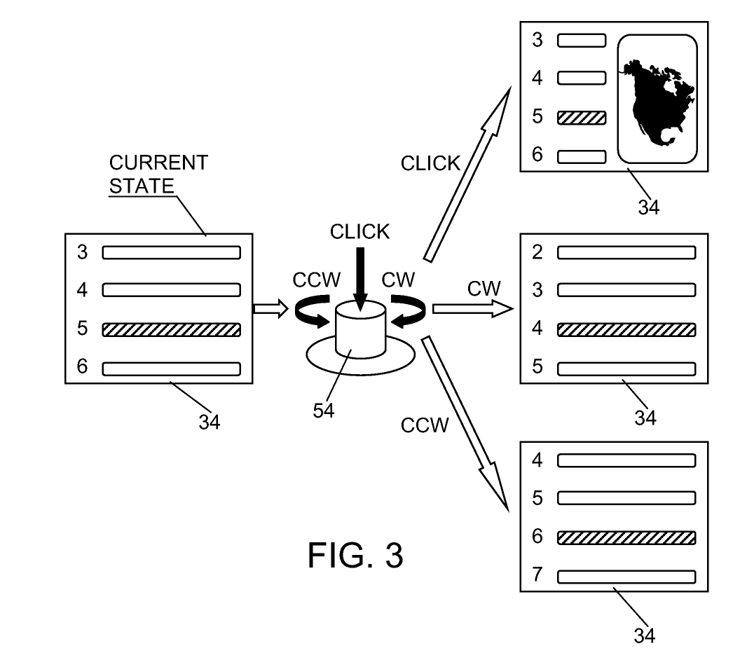

FIG. 3 is a schematic overview for illustrating a process of pre-caching data in view of a number of actuation possibilities of an input device. FIG. 3 shows a rotary-push knob 54 as an input device. The rotary-push knob 54 can be actuated in three different ways. The rotary-push knob 54 can be clicked by pressing or pushing the rotary-push knob 54 downward; it can be rotated in a clockwise direction and it can be rotated in a counterclockwise direction. The actuation of the rotary-push knob 54 by clicking, i.e. pushing, is indicated by a downward arrow labeled CLICK. The clockwise rotation of the rotary-push knob 54 is indicated by an arrow labeled CW, which points in the clockwise direction. The counterclockwise rotation of the rotary-push knob 54 is indicated by an arrow labeled CCW, which points in the counterclockwise direction. The rectangle to the left of the rotary-push knob 54 illustrates a current state.

In accordance with an embodiment of the invention, the rectangle may represent a display screen 34 which displays four options, namely options 3, 4, 5, and 6. The user can scroll through the options by rotating the rotary-push knob 54 in a clockwise direction or in a counterclockwise direction. A respective one of the options which can be selected by clicking the rotary-push knob 54 is highlighted on the display screen 34. In the example shown in FIG. 3, option number 5 is highlighted and can be selected simply by clicking the rotary-push knob 54. The selection process by pressing or rotating the rotary-push knob 54 is indicated by the three rectangles to the right of the rotary-push knob 54 in FIG. 3, wherein the three rectangles to the right of the rotary-push knob 54 indicate three different states for the display screen 34.

The three states shown to the right of the rotary-push knob 54 in FIG. 3 can be selected by actuating the rotary-push knob 54. The first state can be selected by clicking the rotary-push knob 54. The second state and the third state can be selected by rotating the rotary-push knob 54 clockwise and, respectively, counterclockwise. The selection of the three different states is indicated by the arrows labeled CLICK, CW and CCW indicating that the rotary-push knob 54 is actuated by pressing it, rotating it clockwise or rotating it counterclockwise. The system may go from the current state into three different states depending on the rotary-push knob 54 actuation. In case the evaluation of real-time measurements of body movements and statistical data predicts a user interaction with this rotary-push knob 54, then the ideal situation would be to have all of the three highly possible imminent states cached and made ready for fast access and delivery.

The method according to the invention is based on the concept of predicting a user intent, in other words predicting an imminent user request, in order to more effectively deliver the data required for the user request. The data are for example information data, graphics data, sound data and data for animations related to the user request. This prediction of a user-intent is achieved by comparing the real-time measurements of body movements of the user and user-dependent statistical data. The body movements include for example hand movements, head movements, body movements causing a variation in a weight distribution and eye movements which may be captured by eye-tracking. Specifically, by ascertaining the real-time location of the hand of the user, for example, it is possible to gather information about which of the main input regions 12, 14, 16, 18, 20 the user is trying to reach.

Correspondingly, detecting that the user is looking at a particular main input region or input device, such as a touchscreen, provides an indication that the user may potentially interact with the input device that the user is looking at. As mentioned above, a variation in the weight distribution plays a significant role when predicting a user intent if the input device that the user tries to reach is positioned such that the user has to extend his or her arm or has to lean toward an input region. The variation in the weight distribution is typically a function of the location of the input device and of the size of the user.

In accordance with an embodiment of the invention, touch sensors, such as capacitive sensors or resistive sensors, are embedded in input devices. The embedded touch sensors can be used to increase the confidence level of the prediction of the intention of the user because there may be a short period of time between the moment when the user just touches an input device and the user finally actuates the input device.

The second aspect of predicting the user intent is the evaluation of statistical data related to user interactions with the input devices. In accordance with a preferred embodiment, historic statistical data that reflect the interactions of a particular user with the input devices are evaluated in order to increase the confidence level of the prediction of the user intent.

The method according to the invention pre-processes data, such as data for a graphical output and/or data for transitions that are possible at a given state of a program depending on the probable intent of the user. The method combines statistical data with real-time measurements of movements of the body of the user with respect to input devices in order to deduce imminent inquiries. As mentioned above, measuring body movements may include measuring a hand location, head movements, eye-tracking or a weight distribution. The method according to the invention is therefore particularly advantageous in a system such as a motor vehicle, in which input devices occupy a significant area at a certain distance from the user. In other words, the method according to the invention is particularly advantageous for a system that requires a significant and measurable movement of the body of the user so that the group of input devices that the user intends to operate can be predicted with a sufficient certainty.

As explained above, an advantage of pre-processing data in accordance with the method of the invention is that less processing power, for example image processing power, is required and thus costs associated with hardware are reduced. Conversely, a more complex graphical user interface is possible and smoother graphics and animated transitions can be achieved, especially if graphic files are located in a relatively slow storage medium.

With respect to the method of the invention, the following aspects are considered to be suitable for performing the method. The steps of acquiring, computing, and storing statistical data on the interactions of each independent user may include detecting and evaluating the amount of times each of the input devices is actuated and/or the time of the day when each of the input devices is actuated. The steps of acquiring, computing, and storing statistical data may further include ascertaining a probability of choosing each of the input devices given a specific history of inputs previously chosen and/or body movements of the user, such as hand movements, head movements, eye-tracking, and variations in a weight distribution. The steps of acquiring, computing, and storing statistical data may additionally include detecting and evaluating time periods between the body movements, such as the hand movements, head movements, eye-tracking and variations in a weight distribution and the actuation of an input device in order to assess how much time for pre-processing will likely be available.

As already described above, another aspect of the invention is the user intent prediction by combining real-time measurements of the user's body movements with respect to the input devices and user-dependent statistical data. The user-intent prediction can also be performed by the use of touch sensors embedded in input devices. As mentioned above, the touch sensors can for example be embodied as capacitive sensors and resistive sensors and the input devices are for example buttons, knobs, touchscreens and touchpads. In accordance with another aspect of the invention, a pre-processing, such as a pre-caching, of files required for an imminent output is performed in dependence on the predicted user intent.

In the following, an exemplary scenario for the use of the invention is provided. Assuming that a user has been using a system according to the invention for a year and the system has the following statistical data about this user. First, the majority, in this case 92%, of the user's inquiries were done by using the main knob (rotary-push knob 54) of the system located in the third main input region 18, 20. Second, only a minority, in this case 8%, of the user's inquiries were done by using a touchscreen (display screen 34) of the system located in the second main input region 16 on the center stack 32 of the vehicle. Third, all of the inquiries that were done by using the touchscreen (display screen 34) were related to radio adjustments. Fourth, it takes an average of one second between the body movement detection and the input device actuation.

In accordance with a preferred embodiment, the above-mentioned statistical data may be obtained through the use of conventional movement monitoring systems. The statistical data may be organized for each independent user of the system. In the specific exemplary scenario described above, it is clear that, if the hand of the user is detected as moving towards the touchscreen after the user has glanced at the touch screen, then it is highly likely that the user will change the settings of the radio. Thus, it would be expedient to use the time period that the system has between the detection of the user movement and the actuation of the input device to pre-cache the data required for a touchscreen actuation. In this particular example, the time period between the user movement and the actuation is on average one second, which allows pre-processing data by pre-caching data for an imminent system state.

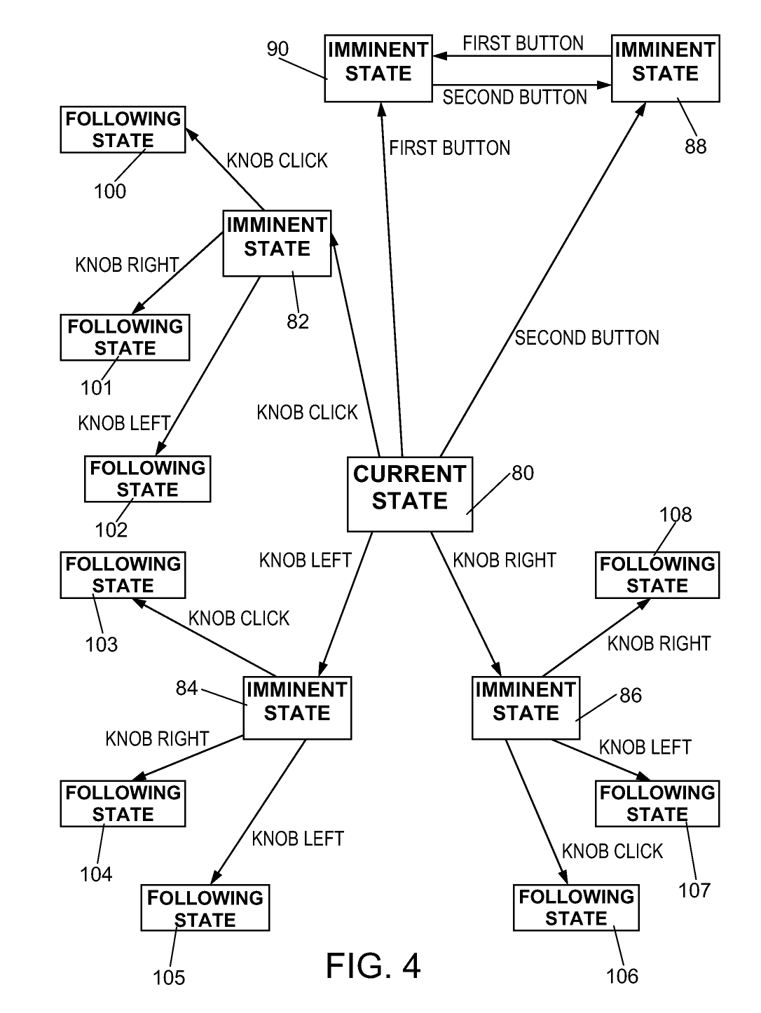

In accordance with another embodiment, a system may be configured such that not only the next imminent state of the program is cached, but a number of successive states is cached. FIG. 4 is a schematic overview for illustrating an exemplary process of pre-caching successive program states or system states in response to actuating an input device according to the invention. A current state 80 of the program is indicated by a box in the center of FIG. 4. A transition from the current state to a new state can be achieved by actuating input devices. In the example shown in FIG. 4, there are three input devices, namely a rotary-push knob, a first button, and a second button. The rotary-push knob can be actuated by either clicking the rotary-push knob, by rotating the rotary-push knob to the left (counterclockwise) or by rotating the rotary-push knob to the right (clockwise). The first button and the second button can be actuated by pressing the buttons.

The arrows in FIG. 4 indicate how a transition between various states can be achieved by actuating the input devices. A first group of arrows extends from the current state 80 to possible imminent states 82, 84, 86, 88, 90. A transition from the current state to one of the possible imminent states 82, 84, 86, 88, 90 is achieved by actuating one of the input devices. In the particular example shown in FIG. 4, the imminent states 82, 84, 86, 88, 90 are indicated by boxes which are connected to the current state 80 by arrows. The arrows are labeled with a description of the type of actuation that is necessary for a transfer from the current state 80 to the respective imminent state. A second group of arrows extends from the imminent states 82, 84, 86 to respective following program states 100-108. The transition from an imminent state to one of the following program states is achieved by actuating the rotary-push knob. The arrows indicting the transitions between states are labeled with a description of how the respective input device has to be actuated for a transition between the states.

Pre-caching more than one state level will allow smoother man-machine interactions, especially if the user can make more than one inquiry in a short period of time. This is for example the case when the user can scroll through multiple options by turning a rotary-push knob and can select one of the options by clicking the rotary-push knob. In this case, the user performs multiple actuations by turning the rotary-push knob and therefore it is expedient to pre-cache not only the data for a single imminent state but the data for several imminent states. The feasibility of pre-caching data for multiple states depends mainly on the level of complexity of the program, the processing power available in the system, the free storage memory available, the confidence level of the prediction of the intention of the user, and the time between inquiries.

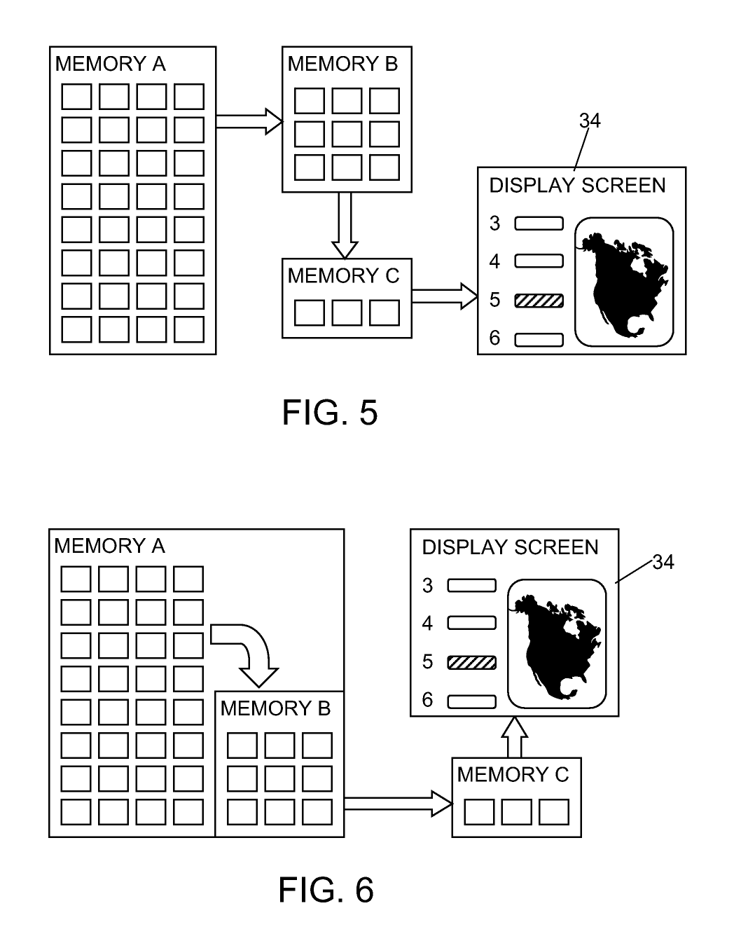

FIG. 5 is a schematic diagram of an exemplary embodiment of a caching memory configuration for implementing the method according to the invention. Memory A is the mass storage medium where all the files are located. Memory A may for example be a hard drive or a DVD (digital versatile disc). The files stored in the mass storage medium are typically stored in a compressed fashion. As is indicated by an arrow, files can be sent from memory A to memory B. Memory B is intended to store pre-processed files. Memory B would for example store the files for the possible imminent states in FIG. 4. Memory B would also store the program states following the imminent program states in FIG. 4. Memory B may have a lower storage capacity than memory A; however, the data transfer in memory B is faster than in memory A. Files in memory B can be sent to memory C. Memory C is a fast-access memory intended to store only files that are to be displayed imminently. As indicated in FIG. 5, memory C has a limited capacity. Memory C would for example store only the files for the possible imminent states in FIG. 4. Finally, data stored in memory C are used for displaying information on the display screen 34.

FIG. 6 is a schematic diagram of another exemplary embodiment of a memory configuration for implementing the method according to the invention. In cases when a significant amount of pre-processing is involved, an even simpler memory configuration than the memory configuration shown in FIG. 5 may be beneficial. FIG. 6 illustrates such a memory configuration. When compared to the memory configuration of FIG. 5, the memory configuration of FIG. 6 omits one physical memory. In FIG. 6, memory A is a mass storage medium where all the files are located. In this case, memory B is a partition of memory A. Memory B, i.e. a partition of memory A, is again intended for pre-processed files. Just like in the case of the above-described memory configuration, memory B would for example store the files for the possible imminent states in FIG. 4 and also the program states following the imminent program states in FIG. 4.

The memory configuration of FIG. 6 also utilizes a fast-access memory for additional caching in the manner described for the memory configuration of FIG. 5. In the memory configuration of FIG. 6, a memory C is for example a fast access memory with a limited capacity. Memory C is intended to allocate only files that are to be displayed imminently. Memory C would for example store only the files for the possible imminent states in FIG. 4. The data files stored in memory C are thus readily available for the display screen 34.

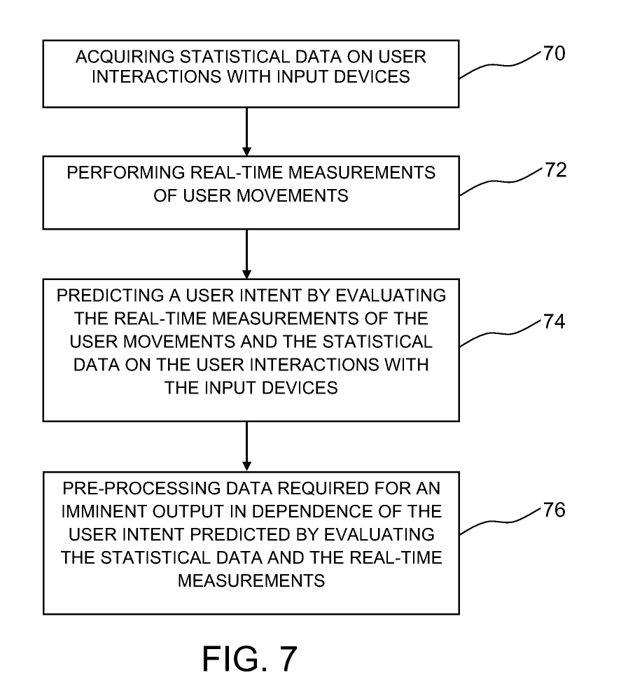

FIG. 7 is a flow chart illustrating basic steps of the method according to the invention. In step 70, statistical data on user interactions with input devices are acquired in accordance with the criteria described above. In step 72, user movements, such as hand movements, are measured in real time. In step 74, a user intent is predicted based on an evaluation of the real-time measurement of the user movements and the statistical data on the user interactions with the input devices. In step 76, data required for an imminent output are pre-processed, for example pre-cached, in dependence of the predicted user intent.

As mentioned above, the method according to the invention is particularly advantageous in automotive applications. An exemplary application of the method according to the invention is its use in an in-vehicle navigation system. The interaction with the map of the in-vehicle navigation system illustrates advantages of the method. All the data required for generating the maps, such as road map vectors and points of interest, are stored in a mass storage medium, which is typically a DVD or a hard drive. When the user interacts with the map, for example by using a zoom function for zooming in in order to display a more detailed map view or for zooming out in order to get an overview of a larger map area, then the pertinent files are searched in the mass storage medium. Once these files are found, they are retrieved, uncompressed, and finally put together to form a map on the display screen 34. The use of the method for processing data in accordance with the invention improves the efficiency of the above-described operation because files that have a high probability of being required, such as files required for zooming out and zooming in from a current location on the map, are searched, processed, cached, and quickly delivered when requested by the user.

What is claimed is:

1. A method for processing data, comprising:
providing statistical data on user interactions with input devices;
performing a real-time measurement of a user movement;
predicting a user intent by evaluating the real-time measurement of the user movement and the statistical data on the user interactions with the input devices; and
pre-processing data required for an imminent output in dependence of the user intent predicted by evaluating the statistical data and the real-time measurement.

2. The method according to claim 1, which comprises detecting an amount of times each of the input devices is actuated in order to provide statistical data on user interactions with the input devices.

3. The method according to claim 1, which comprises detecting time stamp information when a respective one of the input devices is actuated in order to provide statistical data on user interactions with the input devices.

4. The method according to claim 3, wherein the step of detecting time stamp information includes detecting at least one item of time information selected from the group consisting of a time of a day and a day of a week.

5. The method according to claim 1, wherein the step of providing statistical data on user interactions with the input devices includes calculating a probability of choosing a respective one of the input devices in dependence of a given history of inputs previously chosen.

6. The method according to claim 1, wherein the step of performing a real-time measurement of a user movement includes measuring a user movement selected from the group consisting of a hand movement, a head movement, an eye movement and a variation in a weight distribution.

7. The method according to claim 1, which comprises:
measuring a first time period elapsing between a detection of a user movement and an actuation of an input device; and
assessing a second time period available for pre-processing data required for an imminent output in dependence of the first time period elapsed between the detection of the user movement and the actuation of the input device.

8. The method according to claim 1, which comprises using touch sensors embedded in respective ones of the input devices in order to provide a real-time measurement of a user movement.

9. The method according to claim 8, which comprises using a touch sensor selected from the group consisting of a capacitive touch sensor and a resistive touch sensor and using an input device selected from the group consisting of a button, a knob, a touchscreen and a touchpad.

10. The method according to claim 1, wherein the step of pre-processing data includes at least one data operation selected from the group consisting of a data file search, a data file uncompressing, a data file assembly, a data file pre-caching and a data file modification.

11. The method according to claim 1, wherein the step of pre-processing data includes pre-caching data files for a first imminent output related to a first system state and for a second imminent output related to a second system state, wherein the second system state succeeds the first system state.

12. The method according to claim 1, wherein the step of pre-processing data includes pre-caching data files required for an imminent output on a display by moving the data files from a first memory to a second memory, wherein the second memory allows a faster data access than the first memory.

13. The method according to claim 1, which comprises:
identifying a given user; and
providing user-specific statistical data on user interactions with the input devices by evaluating the user interactions of the given user in order to ascertain user-specific preferences.

14. The method according to claim 1, which comprises providing context-specific statistical data on user interactions with the input devices by evaluating a driving situation.

15. The method according to claim 14, wherein the step of evaluating a driving situation includes evaluating information available in a vehicle information network system.

16. The method according to claim 14, wherein the step of evaluating a driving situation includes evaluating at least one vehicle parameter selected from the group consisting of a vehicle speed, a steering angle, a gas pedal position, a turning signal activation, a vehicle acceleration and a vehicle brake actuation.

17. The method according to claim 1, which comprises performing, as a user interaction, a task selected from the group consisting of interacting with a stereo system, interacting with a navigation system, interacting with a climate control system and interacting with a vehicle information system.
